(19) United States
(12) Patent Application Publication
(10) Pub. No.: US 2009/0051878 A1
(43) Pub. Date: Feb. 26, 2009

(54) STEREO PROJECTION OPTICAL SYSTEM

(75) Inventors: CHIEN-WEN HSU, Tu-Cheng (TW); CHIA-HUNG KAO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/947,086

(22) Filed: Nov. 29, 2007

(30) Foreign Application Priority Data
Aug. 21, 2007 (CN) 200710201421.0

(51) Int. Cl. G02B 27/26

(52) U.S. Cl. 353/8

(57) ABSTRACT

A stereo projection optical system, includes a first polarizing beam splitter configured for separating a light input into a first polarized light component and a second polarized light component; a first image assimilator positioned to receive the first polarized light component; a first image assimilator positioned to receive the second polarized light component; a fourth polarizing beam splitter positioned to receive the light outputs of the first, second image assimilators. The first, second image assimilators to project two images formed by the first polarized light component and the second polarized light component with spatial information in the stereo projection optical systems. When viewers wear glasses that have two polarizing lenses whose polarization directions are perpendicular to each other, the viewers can perceive projected images as three-dimension.

### RELATED FIELD

The present invention relates generally to projection optical systems, and more specifically to a stereo projection optical system.

### BACKGROUND

Various types of stereoscopic projection optical systems are well known in the art. Such stereoscopic projection optical systems typically include two projectors arranged in parallel so that images from a liquid crystal display (LCD) panel or a slide film are projected on a screen by each light source. As shown in FIG. 4, a conventional stereoscopic projection optical system includes spherical reflective mirrors 1 and 1′, lamps 2 and 2′, condenser members 3 and 3′, LCD panels 4 and 4′, and projection lenses 5 and 5′.

In the conventional stereoscopic projection optical system, the stereoscopic picture is obtained by making the polarizing directions of projected beams perpendicular to each other. This is achieved by using two projectors. The picture from the right projector is only visible to the right eye of a viewer, and the picture from the left projector is only visible to the left eye of a viewer.

In the conventional stereoscopic projection optical system, the lamps 2, 2 are independently operated. When the beams from each of the lamps 2, 2′ pass through the LCD panels 4, 4′ respectively, the beams are respectively polarized in the direction of a polarizing axis of a polarizing plate attached to the light source side of the corresponding LCD panels 4, 4′. As a result, a half of the beams condensed by each of the condenser members 3 and 3′ is absorbed by the polarizing plate before passing through the corresponding LCD panels 4, 4′. The lost light is absorbed as heat by the polarizing plate. This is necessitates a separate cooling device to increase the heat-dissipating efficiency at the polarizing plates of the LCD panels 4, 4′.

It is desired to provide a stereo projection optical system which can overcome the above-described deficiencies.

### SUMMARY

In accordance with an exemplary embodiment, a stereo projection optical system includes a first polarizing beam splitter, a first image assimilator having a second polarizing beam splitter, a second image assimilator having a third second polarizing beam splitter and a fourth polarizing beam splitter. The first polarizing beam splitter is configured for separating a light input into a first polarized light component and a second polarized light component which is substantially orthogonal to the first polarized light component. The first image assimilator is positioned to receive the first polarized light component and also includes a first reflective spatial light modulator. The second polarizing beam splitter is configured for receiving and reflecting the first polarized light component in the first reflective spatial light modulator. The first reflective spatial light modulator is configured for converting the first polarized light component into the second polarized light component and emitting the second polarized light component into the second polarized beam splitter. The second polarizing beam splitter further configured for allowing the second polarized light component to transmit directly therethrough. The second image assimilator is positioned to receive the second polarized light component and also includes a second reflective spatial light modulator. The third polarizing beam splitter is configured for receiving the second polarized light component and allowing it to transmit into the second reflective spatial light modulator. The second reflective spatial light modulator is configured for converting the second polarized light component into the first second polarized light component and emitting the first polarized light component into the third polarizing beam splitter. The third polarizing beam splitter is further configured for reflecting the first polarized light component. The fourth polarizing beam splitter is positioned to receive the second and first polarized component output from the first and second image assimilators, and configured for allowing the second polarized light component to transmit directly therethrough and reflecting the first polarized light component, such that the first and second polarized light component are output from the fourth polarizing beam splitter in substantially the same direction.

Other novel features and advantages will become more apparent form the following detailed description when taken in conjunction with the accompanying drawings.

### BRIEF DESCRIPTION OF THE DRAWINGS

The present invention is described in detail hereinafter, by way of example and description of preferred and exemplary embodiments thereof and with reference to the accompanying drawings, in which:

FIG. 1 illustrates a configuration of a stereo projection optical system in accordance with a first embodiment of the present invention;

FIG. 2 is similar to FIG. 1, but further illustrates a plurality of analyzers disposed in the stereo projection optical system;

FIG. 3 illustrates a configuration of a stereo projection optical system in accordance with a second embodiment of the present invention; and

FIG. 4 illustrates the configuration of a conventional stereoscopic projection optical system.

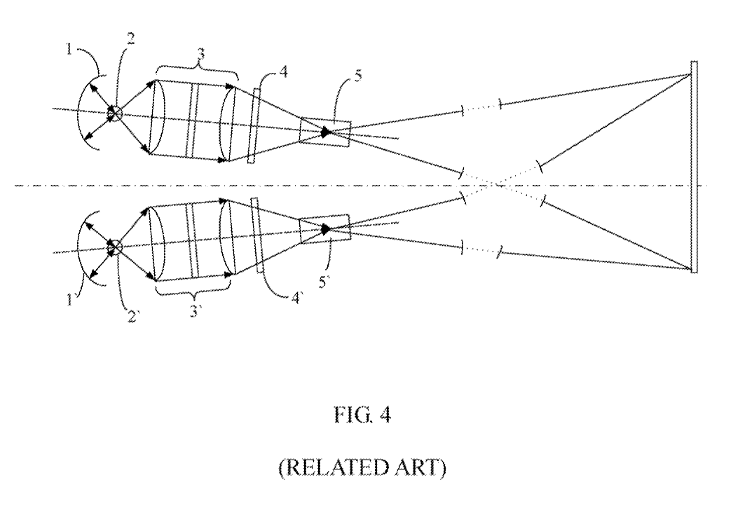

### DETAILED DESCRIPTION OF THE PREFERRED EMBODIMENTS

A detailed explanation of a stereo projection optical system for projection displays according to each of various embodiments of the present invention will now be made with reference to the drawings attached hereto.

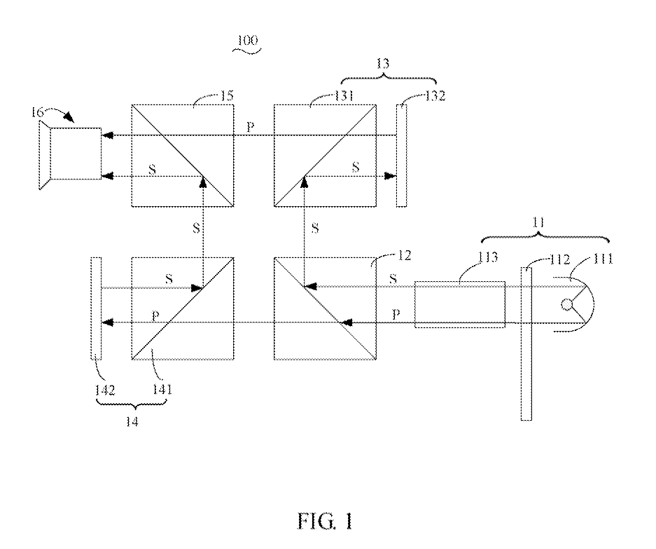

Referring to FIG. 1, a stereo projection optical system 100 according to a first embodiment in the present invention is shown. The stereo projection optical system 100 includes a light source assembly 11, a first polarizing beam splitter (PBS) 12, a first image assimilator 13 having a second PBS 131, a second image assimilator 14 having a third PBS 141, a fourth PBS 15, and a projection lens 16.

The light source assembly 11 includes a light source 111, a color wheel 112 positioned to receive light of the light source 111, and a integrator 113 positioned to receive the light emerging form the color wheel 112. The light source 111 can be a halogen lamp, a metal halogen lamp, a light emitting diode (LED), and the like. In the present embodiment, the light source 111 is a halogen lamp. The color wheel 112 is configured for splitting the light output from the light source 111 into time-sequenced red, green and blue light beams. The color wheel 112 includes red, green and blue color filters, and the center of the color wheel 112 is connected to a motor (not shown) such that the color wheel 112 is rotated. The integrator 113 is configured for processing the light emitted from the color wheel 112 such that light beams exiting the integrator 113 have a uniform spatial distribution.

The first PBS 12 is positioned to receive light output form light source assembly 11; and is configured for separating the non-polarized light from the light source assembly 11 into a first polarized light component and a second polarized light component which is substantially orthogonal to the first polarized light component. The first polarized light component can be S-polarized light or P-polarized light. When the first polarized light component is S-polarized light, the second polarized light component is P-polarized light. In the present embodiment, the first polarized light component is S-polarized light, and the second polarized light component is P-polarized light. The first polarized light component is reflected sideways by the first PBS 12 and the second polarized light component transmits directly through the first PBS 12. The first PBS 12 can be a wire grid polarizer (WGP) or a polarizing beam splitter prism. In the present embodiment, the first PBS 12 is a polarizing beam splitter prism.

The first and second image assimilators 13, 14 are respectively disposed in the light paths of the first, second polarized light components emitted from the first PBS 12. Configurations and working principles of the first and second image assimilators 13, 14 are substantially same. Thus for convenience, only a configuration and a working principle of the first image assimilator 13 is explained in detail herein.

The first image assimilator 13 includes a first spatial light modulator (SLM) 132 and the second PBS 131. A configuration and working principle of the second PBS 131 are substantially same as those of the first PBS 12. The second PBS 131 is configured for receiving the first polarized light component and reflecting it. The first SLM 132 is reflective type SLM, and can be a liquid crystal on silicon (LCoS) panel. The first SLM 132 is configured for modifying the polarization of the first polarized light component in a predetermined manner and superimposing spatial information on the first polarized light component, such that the first polarized light component is converted to a second polarized light component. The polarization direction of the second polarized light component is substantially orthogonal to the polarization direction of the first polarized light component. The first SLM 132 emits the second polarized light component to the second PBS 131, and the second polarized light component passes directly through the second PBS 131.

The second image assimilator 14 also includes a second SLM 142, which is substantially same in principle as the first SLM 132 of the first image assimilator 13. The second image assimilator 14 is disposed in the light path of the second polarized light component emitted from the first PBS 12. The second polarized light component passes directly through the third PBS 141 and reaches the second SLM 142. The second SLM 142 converts the second polarized light component into the first polarized light component, whose polarization direction is substantially orthogonal to the polarization direction of the second polarized light component. The second SLM 142 emits the first polarized light component to the third PBS 141, and the first polarized light component is reflected sideways of the third PBS 141.

The fourth PBS 15 is configured for receiving the second and first polarized light components from the first and second image assimilators 13, 14 respectively and combining the two light beams into a single light output. In particular, the second polarized light component passes directly through the fourth PBS 15, and the first polarized light component is reflected sideways by the fourth PBS 15.

The projection lens 16 is configured for receiving the light output of the fourth PBS 15, and magnifying the light output and projecting an image on a screen (not shown).

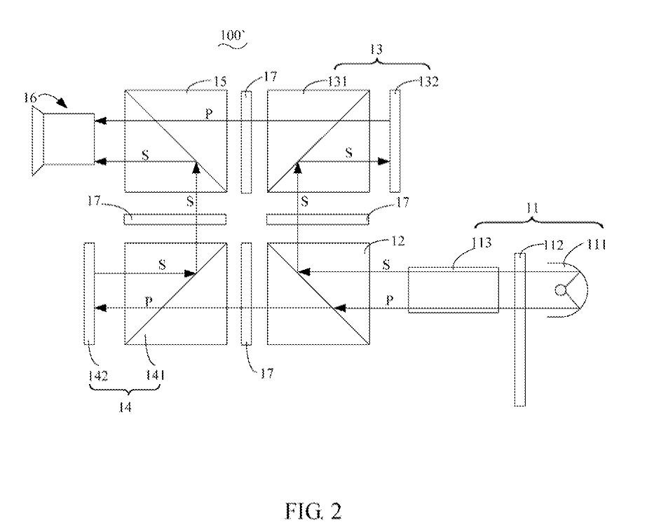

It should be understood that the stereo projection optical system 100 can also include a plurality of analyzers 17 in order to promote contrast of images projected by the stereo projection optical system 100. Referring to FIG. 2, the shows four analyzers 17 incorporated in a stereo projection optical system 100′. Each of the analyzers 17 can be a polarizer, which is configured for transmitting light of a predetermined polarization direction and blocking light of other polarization directions. In alternative embodiments, the analyzers 17 can have other desired light process characteristics. The plurality of analyzers 17 can be disposed is any one and more of the following positions: between the first PBS 12 and the first image assimilator 13, between the first PBS 12 and the second image assimilator 14, between the first image assimilator 13 and the fourth PBS 15, and between the second image assimilator 14 and the fourth PBS 15. In the present embodiment, four analyzers 17 are respectively disposed in the these four positions. The following two analyzers 17 transmit P-polarized light and remove S-polarized light: the analyzer 17 between the first PBS 12 and the first image assimilator 13, and the analyzer 17 between the second image assimilator 13 and the fourth PBS 15. The following other two analyzers 17 transmit S-polarized light and remove P-polarized light: the analyzer 17 between the first PBS 12 and the first image assimilator and the analyzer 17 between the second image assimilator 14 and the fourth PBS 15.

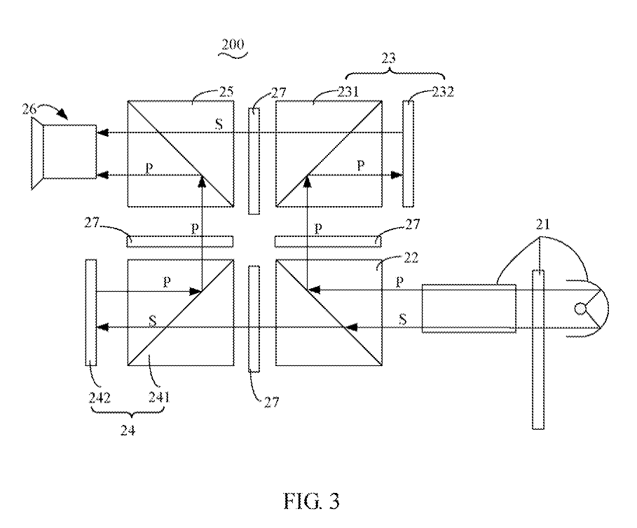

Referring to FIG. 3, a stereo projection optical system 200 according to a second embodiment in the present invention is shown. The stereo projection optical system 200 is similar to the stereo projection optical system 100′ of the first embodiment. However, the stereo projection optical system 200 includes a light source assembly 21, a first PBS 22, a first and second image assimilators 23, 24 respectively having a second PBS 231 and a third PBS 241, a fourth PBS 25, and a projection lens 26.

Similar to the first embodiment, the first image assimilator 23 includes a first SLM 232, and the second image assimilator 24 includes a first SLM 242. The difference between the first embodiment and the second embodiment is that the first, second, third, and fourth PBSs 22, 231, 241, and 25 each transmit S-polarized light and reflect P-polarized light. Other optical elements and light paths in the stereo projection optical system 200 are substantially the same as in the first embodiment.

The stereo projection optical system 200 includes a plurality of analyzers 27, in order to promote contrast of the images projected by the stereo projection optical system 200. The locations of the analyzers 27 are substantially the same as the analyzers 17 of the first embodiment. It should be understood that in alternative embodiments, more or all of the analyzers 27 can be omitted.

In each of the above-described stereo projection optical system 100, 100′, and 200, the first and second image assimilators respectively generate two images formed by the first polarized light component and the second polarized light component with spatial information. When a viewer wears glasses that have two polarizing lenses whose polarization directions are perpendicular to each other, the viewer can perceive projected images as being three-dimensional. As described above, each PBS splits an incident beam into two beams, and the two SLMs obtain image beams and generate corresponding image beams having spatial information. All the image beams having spatial information are simultaneously projected on a screen as a 3-D image. The efficiency of light utilization is high; with little power loss is of light compared to the conventional systems.

It should be understood that the above-described embodiment are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A stereo projection optical system, comprising:
a first polarizing beam splitter configured for separating a light input into a first polarized light component and a second polarized light component which is substantially orthogonal to the first polarized light component;
a first image assimilator positioned to receive the first polarized light component and comprising a second polarizing beam splitter and a first reflective spatial light modulator, the second polarizing beam splitter configured for receiving the first polarized light component and reflecting it into the first reflective spatial light modulator, the first reflective spatial light modulator configured for converting the first polarized light component into the second polarized light component and emitting the second polarized light component into the second polarizing beam splitter, the second polarizing beam splitter further configured for allowing the second polarized light component to transmit directly therethrough;
a second image assimilator positioned to receive the second polarized light component and comprising a third polarizing beam splitter and a second reflective spatial light modulator, the third polarizing beam splitter configured for receiving the second polarized light component and allowing it to transmit into the second reflective spatial light modulator, the second reflective spatial light modulator configured for converting the second polarized light component into the first second polarized light component and emitting the first polarized light component into the third polarizing beam splitter, the third polarizing beam splitter further configured for reflecting the first polarizing light component;
a fourth polarizing beam splitter positioned to receive the second and first polarized light component output from the first and second image assimilator, and configured for allowing the second polarized light component to transmit directly therethrough and reflecting the first polarized light component, such that the first and second polarized light components are output form the fourth polarized beam splitter in substantially the same direction

2. The stereo projection optical system as claimed in claim 1, wherein the first, second, third, and fourth polarizing beam splitters are wire grid polarizers.

3. The stereo projection optical system as claimed in claim 1, wherein the first, second, third, and fourth polarizing beam splitters are polarizing beam splitter prisms.

4. The stereo projection optical system as claimed in claim 1, wherein each of the first, second reflective spatial light modulators is a liquid crystal on silicon panel.

5. The stereo projection optical system as claimed in claim 1, wherein the first polarized light component is one of S-polarized light and P-polarized light and the second polarized light component is the other of S-polarized light and P-polarized light.

6. The stereo projection optical system as claimed in claim 5, wherein the second polarized light component is S-polarized light and the first polarized light component is P-polarized light.

7. The stereo projection optical system as claimed in claim 1, further comprising a projecting lens positioned to receive the light output from the fourth polarizing beam splitter and configured for projecting a corresponding image.

8. The stereo projection optical system as claimed in claim 1, further comprising at least an analyzer respectively disposed in at least one position selected from the group consisting of a position between the first polarizing beam splitter and the first image assimilator, a position between the second image assimilator and the first polarizing beam splitter, a position between the first image assimilator and the fourth polarizing beam splitter, a position between the second image assimilator and the fourth polarizing beam splitter.

9. The stereo projection optical system as claimed in claim 8, wherein each of the at least one analyzer is a polarizer selectively configured for blocking one of the first polarized light component and the second polarized light component, and allowing transmission therethrough of the other of the first polarized light component and the second polarized light component.

10. The stereo projection optical system as claimed in claim 9, wherein each of the at least one analyzer is configured for blocking the first polarized light component and allowing transmission therethrough of the second polarized light component when said each of the at least one analyzer is respectively disposed in at least one position selected from the group consisting of the position between the first polarizing beam splitter and the second image assimilator, and the position between the first image assimilator and the fourth polarizing beam splitter.

11. The stereo projection optical system as claimed in claim 9, wherein each of the at least one analyzer is configured for blocking the second polarized light component and allowing transmission therethrough of the first polarized light component when said each of the at least one analyzer is respectively disposed in at least one position selected from the group consisting of the position between the first polarizing beam splitter and the first image assimilator, and the position between the second image assimilator and the fourth polarizing beam splitter.
